(19) United States
(12) Patent Application Publication
(10) Pub. No.: US 2023/0273392 A1
(43) Pub. Date: Aug. 31, 2023

(54) LENS DRIVING DEVICE, CAMERA MODULE, AND CAMERA-EQUIPPED DEVICE

(71) Applicants: Tomohiko OSAKA, Tokyo (JP); Shun SUZUKI, Tokyo (JP)

(72) Inventors: Tomohiko OSAKA, Tokyo (JP); Shun SUZUKI, Tokyo (JP)

(73) Assignee: Mitsumi Electric Co., Ltd., Tokyo (JP)

(21) Appl. No.: 18/017,888

(22) PCT Filed: Jun. 24, 2021
(86) PCT No.: PCT/JP2021/023919

§ 371 Date: Jan. 25, 2023

Related U.S. Application Data
(60) Provisional application No. 63/059,244, filed on Jul. 31, 2020.

(51) Int. Cl. G02B 7/00; H02N 2/02; G03B 17/12

(52) U.S. Cl. CPC G02B 7/005; H02N 2/02; G03B 17/12

(57) ABSTRACT

This lens driving device comprises a movable part, a driving part that has an ultrasonic motor and drives the movable part in the direction of an optical axis, and a shaft part that extends in the direction of the optical axis and supports the movable part. The driving part has a move section that is supported by the shaft part so as to be movable in the direction of the optical axis, and a support section that is connected to the move section and supports the movable part at a position closer to the optical axis side than the shaft part.

### TECHNICAL FIELD

The present invention relates to a lens driving device, a camera module, and a camera-mounted device.

### BACKGROUND ART

Conventionally, a camera module mounted on a thin camera-mounted device such as a smartphone is known. Such a camera module is known to include a lens driving device having a zoom function for enlarging or downsizing a subject image.

For example, Patent Literature (hereinafter, referred to as “PTL” 1) discloses a configuration including a fixed lens on which light from a subject is incident, two movable lenses on which the light deflected by the fixed lens is incident, and a lens driving part for moving the two movable lenses in the direction of the optical axis.

### CITATION LIST

### Patent Literature

PTL 1
Japanese Patent Application Laid-Open No. 2018-36416

### SUMMARY OF INVENTION

### Technical Problem

In the meantime, for example, from the viewpoint of miniaturization of a camera-mounted device, it is conceivable to use an ultrasonic motor as a driving part. In the case where the ultrasonic motor is used as the driving part, for example, a configuration in which a movable part that holds a movable lens and a drive holder that transmits a driving force of the ultrasonic motor to the movable part are separately disposed is conceivable.

For example, a total of two guide shafts for the drive holder and for the movable part are disposed, and the drive holder and the movable part are connected to each other by a connecting member (a spring member or the like for absorbing a positional deviation between the drive holder and the movable part). The driving force is transmitted to the movable part via the drive holder to move the movable lens.

Further, in order to manage the position of the movable part, for example, a magnet part for position detection is disposed in the drive holder, and the position of the movable part is detected by detecting the position of the drive holder.

However, in the configuration in which the drive holder and the movable part move separately as described above, there is a risk of occurrence of a response delay of the driving force from the drive holder to the movable part and of an inclination of the movable part. In addition, in the configuration in which the position of the movable part is detected by detecting the position of the drive holder, the position of the movable part is not directly detected. Thus, there is a possibility that the position of the movable part cannot be accurately managed.

An object of the present invention is to provide a lens driving device, a camera module, and a camera-mounted device capable of suppressing a response delay of a driving force to a movable part and an inclination of the movable part and accurately managing the position of the movable part.

### Solution to Problem

A lens driving device according to the present invention includes:
a movable part that is capable of holding a movable lens;
a driving part that includes an ultrasonic motor and drives the movable part in a direction of an optical axis; and
a shaft part that extends in the direction of the optical axis and supports the movable part, in which
the driving part includes:
   a moving part supported by the shaft part so as to be movable in the direction of the optical axis, and
   a supporting part that is connected to the moving part and supports the movable part at a position closer to the optical axis than the shaft part is to the optical axis.

A camera module according to the present invention includes:
the aforementioned lens driving device;
a lens part including the movable lens held by the movable part; and
an image capturing part configured to capture a subject image imaged by the lens part, in which
the movable lens is driven in the direction of the optical axis.

A camera-mounted device according to the present invention is
a camera-mounted device that is an information apparatus or a transporting apparatus, the camera-mounted device including:
the above-described camera module; and
an image capturing control part that processes image information obtained by the camera module.

### Advantageous Effects of Invention

According to the present invention, it is possible to suppress a response delay of the driving force to a movable part and an inclination of the movable part, and to accurately manage the position of the movable part.

### BRIEF DESCRIPTION OF DRAWINGS

FIG. 1 schematically illustrates a camera module according to an embodiment of the present invention;

FIG. 2 schematically illustrates a configuration of the camera module as seen in a side view according to the present embodiment;

FIG. 3 is a perspective view illustrating a housing portion of the camera module;

FIG. 4 is a perspective view of a bottom wall portion side of the housing portion of the camera module;

FIG. 5 is an exploded perspective view of a housing and a lens part;

FIG. 6 is an exploded perspective view of a side wall portion and the bottom wall portion of the housing;

FIG. 7 illustrates the housing as seen from the +side in the Z direction;

FIG. 8 is an exploded perspective view of a drive holder and an interposition part;

FIG. 9 is a diagram illustrating a second interposition member;

FIG. 10 is a diagram illustrating the arrangement relationship between the interposition part and an ultrasonic motor;

FIG. 11 is a perspective view of the ultrasonic motor;

FIG. 12 is an exploded perspective view of the ultrasonic motor;

FIG. 13 is an enlarged view of a contact portion between a resonant portion and the interposition part;

FIG. 14A is a view of the drive holder seen from the—side in the Y direction;

FIG. 14B is a sectional view of the drive holder;

FIG. 15A is a diagram for explaining the positional relationship between the magnet and the position detecting part;

FIG. 15B is a diagram for explaining the positional relationship between the magnet and the position detecting part;

FIG. 15C is a diagram for explaining the positional relationship between the magnet and the position detecting part;

FIG. 16A is a diagram illustrating the smartphone in which the camera module is mounted;

FIG. 16B is a diagram illustrating the smartphone in which the camera module is mounted;

FIG. 17A is a diagram illustrating the automobile in which the camera module is mounted; and

FIG. 17B is a diagram illustrating the automobile in which the camera module is mounted.

### DESCRIPTION OF EMBODIMENTS

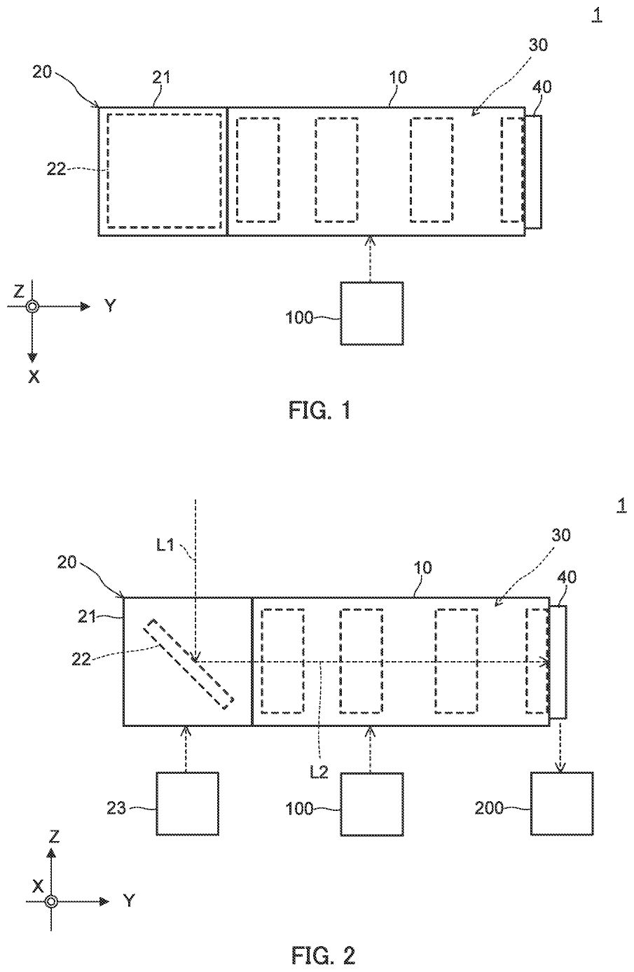

Hereinafter, embodiments of the present invention will be described in detail with reference to the drawings. FIG. 1 is a diagram schematically illustrating camera module 1 according to an embodiment of the present invention. FIG. 2 is a diagram schematically illustrating a configuration of camera module 1 according to the present embodiment as viewed from the side.

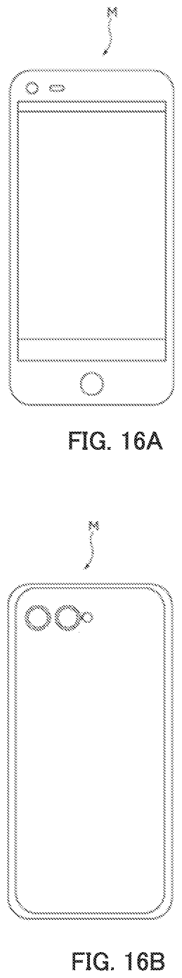

Camera module 1 is mounted in thin camera-mounted devices such as, for example, smartphone M (see FIGS. 16A and 16B), a mobile phone, a digital camera, a notebook personal computer, a tablet terminal, a portable game machine, in-vehicle camera, and the like.

In explaining the structure of camera module 1 of the present embodiment, an orthogonal coordinate system (X, Y, Z) is used. The same orthogonal coordinate system (X, Y, Z) is also used for illustration of below-mentioned figures. Camera module 1 is mounted such that the horizontal direction is the X direction, the vertical direction is the Y direction, and the front-rear direction is the Z direction, for example, during actually capturing an image with a camera-mounted device. Light from a subject is incident from the—side (minus side) in the Z direction, and is deflected and guided to the +side (plus side) in the Y direction. By reducing the thickness of camera module 1 in the Z direction, it is possible to reduce the thickness of the camera-mounted device.

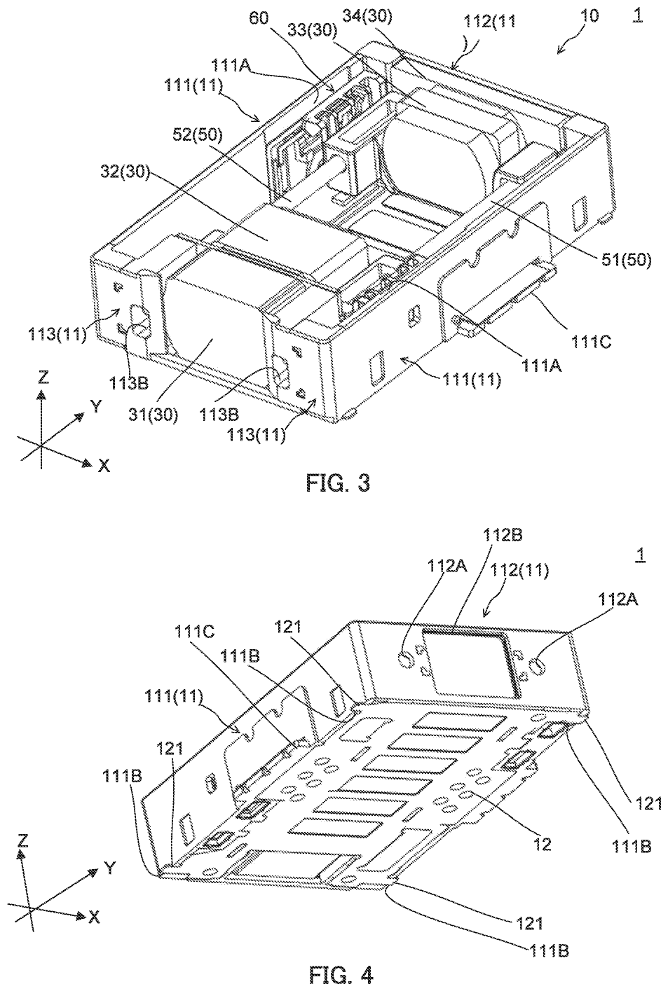

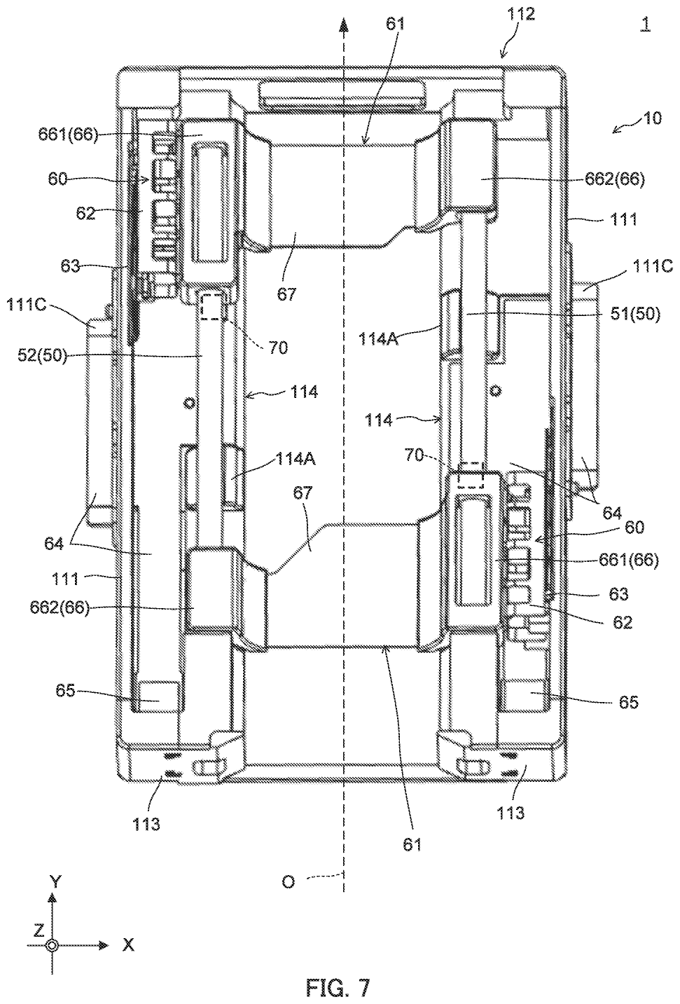

As illustrated in FIG. 1, camera module 1 includes housing 10, reflection driving part 20, lens part 30, image capturing part 40, shaft part 50 (see FIG. 3), lens driving parts 60 (see FIG. 3), position detecting parts 70 (see FIG. 7), and drive control part 100.

Drive control part 100 includes a Central Processing Unit (CPU), Read Only Memory (ROM), Random Access Memory (RAM), or the like. The CPU reads a program suited to processing contents out of the ROM, develops the program in the RAM, and integrally controls an operation of each block of lens driving parts 60 in cooperation with the developed program. Thus, drive control part 100 drives, in the Y direction (the direction of the optical axis), second lens unit 32 and third lens unit 33 to be described later of lens part housed in housing 10. As a result, camera module 1 performs stepless optical zoom and autofocus. Housing 10, shaft part 50, lens driving parts 60, position detecting parts 70, and drive control part 100 correspond to the “lens driving device” of the present invention.

Further, as illustrated in FIG. 2, in camera module 1, incident light L1 is incident on housing 10 via reflection driving part 20. Reflection driving part 20 includes reflecting housing 21, mirror 22, and reflection drive control part 23. In the example illustrated in FIGS. 1 and 2, reflecting housing 21 is disposed adjacent to an end portion of housing 10 on the—side in the Y direction. Mirror 22 is disposed in reflecting housing 21, and reflects incident light L1 toward housing 10 as reflected light L2. Reflection drive control part 23 includes a CPU, a ROM, a RAM, and the like, and controls the orientation of mirror 22.

Mirror 22 according to the present embodiment has two rotation axes (not illustrated) extending in the X direction and the Y direction. In reflection driving part 20, mirror 22 is rotated about the rotation axes under the control of reflection drive control part 23. Thus, camera module 1 has a shake correction function (Optical Image Stabilization (OIS) function) for optically correcting a shake (vibration) that occurs during capturing an image, so as to reduce image irregularities.

Reflected light L2 incident on housing 10 is outputted to image capturing part 40 via lens part 30 accommodated in housing 10.

Image capturing part 40 is disposed on the outer surface of housing 10 on the +side in the Y direction (second wall 112 to be described later), and is configured to allow reflected light L2 to be incident thereon through lens part 30. Image capturing part 40 includes an image capturing device, a board, and the like (not illustrated).

The image capturing device is composed of, for example, a Charge-Coupled Device (CCD) image sensor, a Complementary Metal Oxide Semiconductor (CMOS) image sensor, or the like. The image capturing device is mounted on the board and electrically connected to the interconnections on the board via bonding wires. The image capturing device captures a subject image imaged by lens part 30 and outputs an electrical signal corresponding to the subject image.

Further, a printed wiring board (not illustrated) is electrically connected to the board of image capturing part 40. The power supply to the image capturing device and the output of the electrical signal of the subject image imaged by the image capturing device are performed via the printed wiring board. The electrical signal is outputted to image capturing control part 200 disposed in the camera-mounted device. Image capturing control part 200 includes a CPU, a ROM, a RAM, and the like, and processes image information obtained by camera module 1. Image capturing control part 200 may be mounted on the camera-mounted device, or may also be built in camera module 1.

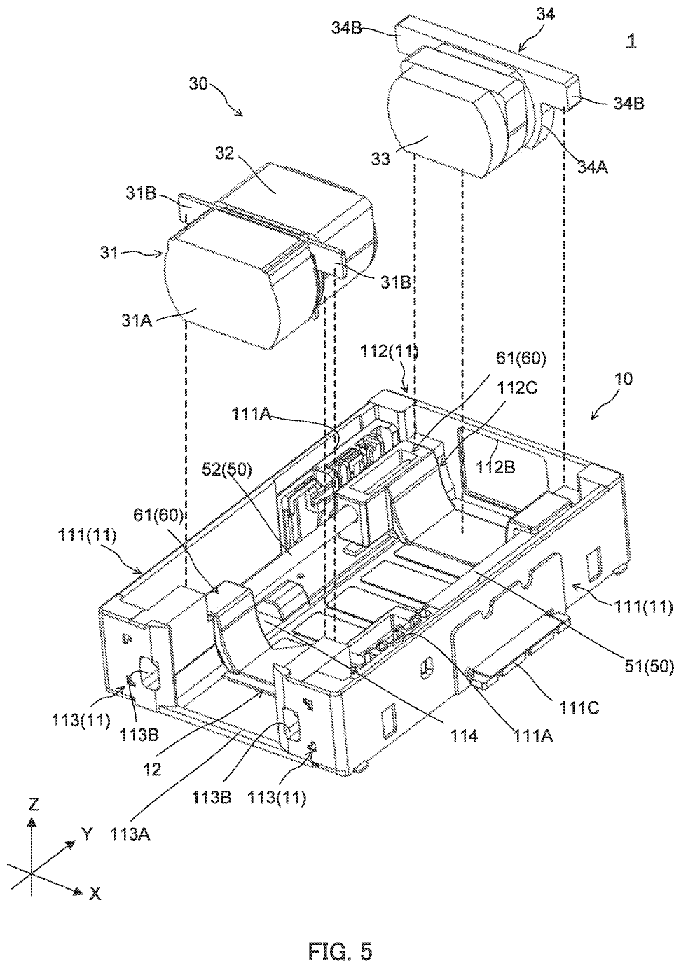

As illustrated in FIG. 3, housing 10 houses lens part 30, shaft part 50, and lens driving parts 60 (see also FIG. 5), and for example, has a rectangular parallelepiped shape as a whole. Housing 10 has side wall portion 11, and bottom wall portion 12.

Side wall portion 11 is a wall portion made of, for example, resin and having a portion opening on the—side in the Y direction, and has first walls 111, second wall 112, third wall 113, and fourth wall 114 (see also FIG. 5 and the like).

A pair of first walls 111 are configured to extend in the Y direction, and are disposed on both sides in the X direction. Placement portion 111A in which an ultrasonic motor to be described later is disposed is disposed on an inner surface of housing 10 at each of first walls 111. Placement portion 111A of first wall 111 on the—side in the X direction is disposed on the +side of housing 10 in the Y direction, and placement portion 111A of first wall 111 on the +side in the X direction is disposed on the—side of housing 10 in the Y direction.

Further, as illustrated in FIG. 4, terminal placement portion 111C is disposed on each of first walls 111. Terminal placement portion 111C includes, for example, board part 64 (see FIG. 7) disposed across the inside and outside of housing 10 via a gap formed between first wall 111 and bottom wall portion 12. A portion of board part 64 disposed outside housing 10 is connected to predetermined interconnections of the camera-mounted device.

Further, engaged portions 111B with which positioning portions 121 of bottom wall portion 12 are engaged are formed in the bottom surface of first wall 111 (the surface on the—side in the Z direction).

As illustrated in FIGS. 3 and 4, second wall 112 is configured to extend in the X direction, and is disposed to connect together the end portions of the pair of first walls 111 on the +side in the Y direction.

Second wall 112 is provided with shaft support portions 112A and opening portion 112B. In the present embodiment, shaft support portions 112A are holes that support first shaft 51 and second shaft 52, which will be described later. Shaft support portion 112A corresponding to first shaft 51 is disposed in second wall 112 on the +side of opening portion 112B in the X direction. Shaft support portion 112A corresponding to second shaft 52 is disposed in second wall 112 on the—side of opening portion 112B in the X direction. Opening portion 112B is an opening through which light passing through lens part 30 (reflected light L2 described above) enters the image capturing device, and is disposed in a central portion of second wall 112 in the X direction.

As illustrated in FIGS. 3 and 5, third walls 113 are disposed respectively on the end portions of the pair of first walls 111 on the—side in the Y direction. The pair of third walls 113 are disposed to surround a space formed by first wall 111 and second wall 112. Between the pair of third walls 113, a gap large enough for first lens unit 31 of lens part 30 to enter there, and bridging portion 113A for bridging the end portions of respective third walls 113 on the—side in the Z direction are disposed.

In addition, shaft support portions 113B for supporting first shaft 51 and second shaft 52, which will be described later, are disposed in the vicinities of central portions of the pair of third walls 113 in the Z direction. Shaft support portion 113B corresponding to first shaft 51 is disposed in third wall 113 on the +side in the X direction, and shaft support portion 113B corresponding to second shaft 52 is disposed in third wall 113 on the—side in the X direction.

Each of shaft support portions 113B is an elongated hole having a length in the Z direction corresponding to a placement area of each of two shaft support portions 112A in second wall 112 described above. Shaft support portions 113B are capable of supporting first shaft 51 and second shaft 52 supported by two shaft support portions 112A of second wall 112, respectively.

As illustrated in FIG. 5, fourth walls 114 form bottom walls on the—side in the Z direction of the space formed by first walls 111, third walls 113 corresponding to first walls 111, and second wall 112, and are disposed in regions corresponding to third walls 113 in the X direction (see also FIG. 7). Therefore, a gap is formed between fourth walls 114 on both sides in the X direction.

As illustrated in FIGS. 4 to 6, bottom wall portion 12 is, for example, a substantially rectangular metal plate forming the bottom wall of housing 10, and is disposed to bridge fourth walls 114 and the pair of first walls 111 on both sides in the X direction. Bottom wall portion 12 is integrated by insert molding with the bottom portions of side wall portions 11 including the bottom portions of the pair of first walls 111. Further, in order that there is not any portion of bottom wall portion 12 at a portion corresponding to first lens unit 31, an end portion of bottom wall portion 12 on the—side in the Y direction is cut out.

Positioning portions 121 are formed on the both lateral ends of bottom wall portion 12 in the X direction. Positioning portions 121 are formed to protrude from the both lateral ends of bottom wall portion 12, and are to be engaged with engaged portions 111B of first wall 111 described above. Thus, it is possible to position bottom wall portion 12 in the Y direction.

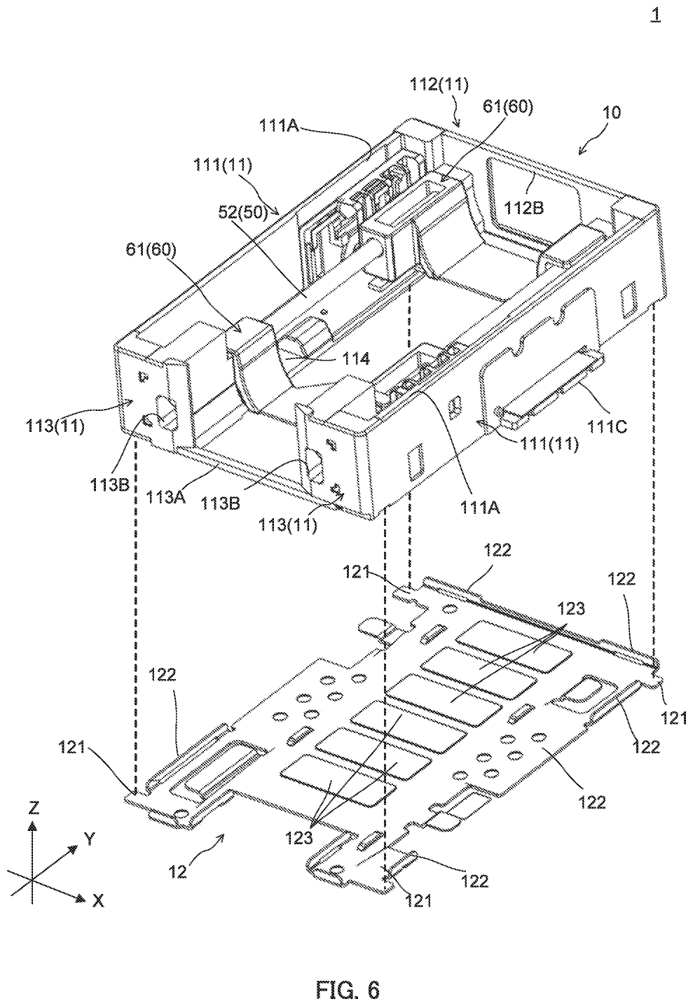

Further, as illustrated in FIG. 6, bent portions 122 are disposed on the lateral ends of bottom wall portion 12 in the X direction and Y direction. Bent portions 122 are formed by bending the lateral ends on the +side in the Z direction.

Further, grooves (not illustrated) in which bent portions 122 are fitted are formed in portions of housing 10 corresponding to bent portions 122. Bent portions 122 are fitted in the grooves, and accordingly, bottom wall portion 12 is fixed to housing 10.

Further, a plurality of half punches 123 disposed in the Y direction are formed in the surface of bottom wall portion 12. Half punches 123 are formed in bottom wall portion 12 over the X direction. In the present embodiment, a total of six half punches 123 are formed.

Such formation of half punches 123 can improve the strength of the bottom wall portion of housing 10.

As illustrated in FIGS. 3 and 5, lens part 30 is disposed in a region that is interposed between the pair of first walls 111 and that includes a region where reflected light L2 from reflection driving part 20 (see FIG. 2) passes. Lens part 30 includes first lens unit 31, second lens unit 32, third lens unit 33, and fourth lens unit 34 that are disposed side by side in the Y direction.

First lens unit 31 is disposed on the most upstream side in the incidence direction of reflected light L2 (the direction toward the +side in the Y direction), and includes main body portion 31A and supported portion 31B.

Main body portion 31A is a portion including a lens, and is configured such that the side surfaces thereof are curved to be convex at their central portions in the Z direction, for example. The side surfaces of third walls 113 on the first lens unit 31 side are shaped, for example, to conform to the side surfaces of main body portion 31A, and are configured such that the curved portions of main body portion 31A are fitted to the side surfaces of third walls 113.

Supported portion 31B is disposed on the +side of main body portion 31A in the Y direction, and includes portions protruding on both sides in the X direction from main body portion 31A. Portions of third walls 113 corresponding to supported portion 31B are configured to be recessed relative to the top surfaces of third walls 113 to allow supported portion 31B to be disposed.

As described above, main body portion 31A is disposed along the side surfaces of third walls 113 and supported portion 31B is supported by third walls 113, whereby first lens unit 31 is fixed between the pair of third walls 113.

Second lens unit 32 is disposed on the downstream side of first lens unit 31 in the incidence direction, and includes a lens through which light passing through first lens unit 31 passes. Second lens unit 32 is configured to be movable by being supported by drive holder 61 to be described later.

Second lens unit 32 corresponds to the “movable part” and the “first movable part” of the present invention. The lens included in second lens unit 32 corresponds to the “movable lens” and the “first movable lens” of the present invention.

Third lens unit 33 is disposed on the downstream side of second lens unit 32 in the incidence direction, and includes a lens (movable lens) through which light passing through first lens unit 31 passes. Third lens unit 33 is configured to be movable by being supported by drive holder 61 to be described later.

Third lens unit 33 corresponds to the “movable part” and the “second movable part” of the present invention. The lens included in third lens unit 33 corresponds to the “movable lens” and the “second movable lens” of the present invention.

Fourth lens unit 34 is disposed on the most downstream side in the incidence direction, and includes main body portion 34A and supported portions 34B. Main body portion 34A includes a lens. Supported portions 34B protrude from the side surfaces of main body portion 34A in the X direction. The inner surface of second wall 112 form lens support portion 112C configured to conform to the shape of fourth lens unit 34. Fourth lens unit 34 is fixed to second wall 112 by being supported by lens support portion 112C.

Note that the lenses in first to fourth lens units 31 to 34 may be assembled to housing 10 at the time of manufacturing the lens driving device, or may be assembled to housing 10 at the time of manufacturing camera module 1 from the lens driving device.

As illustrated in FIGS. 3 and 5, shaft part 50 includes first shaft 51 and second shaft 52 made of, for example, stainless steel. First shaft 51 and second shaft 52 extend in the Y direction and are disposed in respective regions of the pair of third walls 113 in the X direction. First shaft 51 is disposed in a region of third wall 113 on the +side in the X direction. Second shaft 52 is disposed in a region of third wall 113 on the—side in the X direction. In the present embodiment, first shaft 51 and second shaft 52 have the same length, and are supported by shaft support portions 113B of third walls 113 and shaft support portions 112A of second walls 112.

As illustrated in FIG. 7, the pairs of first walls 111, third walls 113, and fourth walls 114 respectively have, for example, substantially the same shapes, and are disposed symmetrically with respect to optical axis O of lens part 30 on both sides in the X direction. First shaft 51 and second shaft 52 are supported by the pair of third walls 113, respectively, and are thus disposed symmetrically with respect to optical axis O.

Lens driving parts 60 are disposed to correspond respectively to second lens unit 32 and third lens unit 33, and independently move corresponding second lens unit 32 and third lens unit 33 under the control of drive control part 100. Lens driving parts 60 are disposed in regions of fourth walls 114 that are surrounded by first wall 111, second wall 112, and third walls 113 and are located on opposite sides in the X direction. That is, lens driving parts 60 are disposed on opposite sides of optical axis O in housing 10 at second lens unit 32 and third lens unit 33, respectively.

In the present embodiment, lens driving part 60 on the +side in the X direction drives second lens unit 32 in the Y direction, and lens driving part 60 on the—side in the X direction drives third lens unit 33 in the Y direction. That is, lens driving part 60 on the +side in the X direction corresponds to the “driving part” and the “first driving part” of the present invention, and lens driving part 60 on the—side in the X direction corresponds to the “driving part” and the “second driving part” of the present invention.

Since each of lens driving parts 60 has substantially the same configuration in the present embodiment, in the following description, only lens driving part 60 corresponding to second lens unit 32 will be described unless otherwise specified, and the description of lens driving part 60 corresponding to third lens unit 33 will be omitted. Further, since lens driving parts 60 are symmetrically disposed in the X direction and the Y direction in the present embodiment, the relationship between the +side and the—side of lens driving part 60 corresponding to third lens unit 33 in the directions is reverse with respect to the relationship between the +side and the—side of lens driving part 60 corresponding to second lens unit 32 in the directions.

Each of lens driving parts 60 includes drive holder 61, interposition part 62, ultrasonic motor 63, board part 64, and boosting part 65.

Drive holder 61 supports one of second lens unit 32 and third lens unit 33.

Drive holder 61 is configured to be movable in the direction of optical axis O by shaft part 50 guiding movement in the direction (Y direction) of optical axis O. When drive holder 61 moves in the direction of optical axis O, second lens unit 32 or third lens unit 33 also moves in the Y direction. Details of drive holder 61 will be described later.

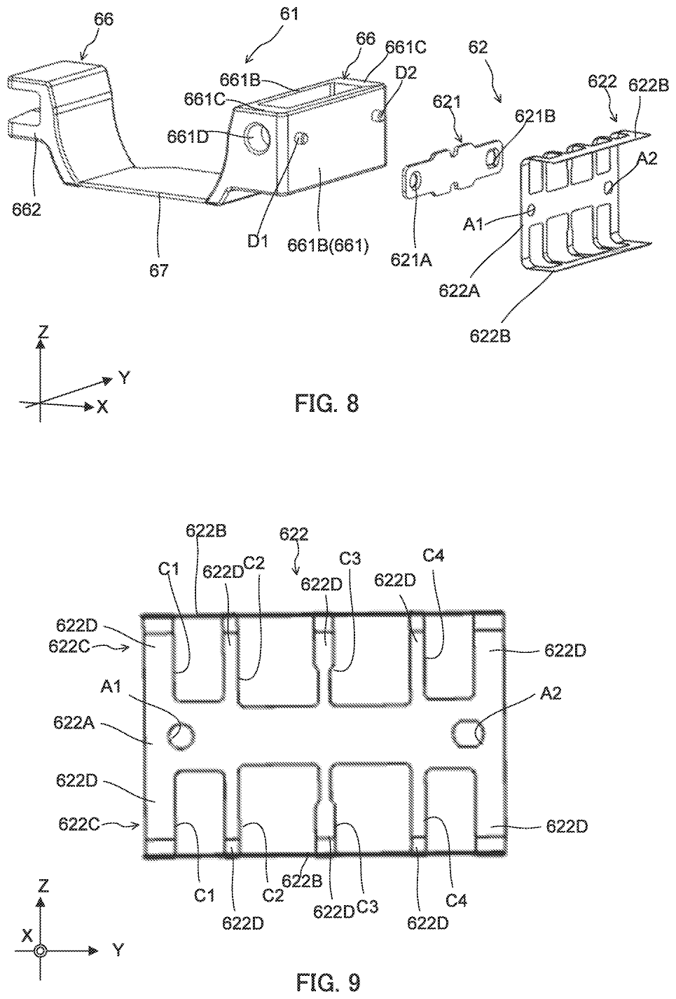

Further, as illustrated in FIG. 8, interposition part 62 includes first interposition member 621 and second interposition member 622.

First interposition member 621 is formed of, for example, a flat plate-shaped metal member, and is bonded to the surface of one of below-described second portions 661B of first supported portion 661 of drive holder 61 that is on the +side in the X direction. Two protrusions D1 and D2 are disposed on the +side of second portion 661B in the X direction.

Two protrusions D1 and D2 protrude from the surface of second portion 661B and are disposed side by side in the Y direction. In the present embodiment, protrusion D1 is disposed in the vicinity of the end portion of second portion 661B on the—side in the Y direction, and protrusion D2 is disposed in the vicinity of the end portion of second portion 661B on the +side in the Y direction.

First interposition member 621 is disposed parallel to the direction of the optical axis (Y direction), and includes engaging holes 621A and 621B that are engaged with two protrusions D1 and D2.

As illustrated in FIGS. 8 and 9, second interposition member 622 is formed of, for example, a flat plate-shaped metal member, and is adhesively fixed to, for example, first interposition member 621. Second interposition member 622 includes main body portion 622A and contact portions 622B.

Main body portion 622A has a flat surface that is parallel to the direction of the optical axis (Y direction), and is adhesively fixed to first interposition member 621. Engaging holes A1 and A2 with which two protrusions D1 and D2 of second portion 661B are engaged are formed in main body portion 622A.

Engaging holes 621A and 621A1 are disposed respectively in the vicinities of the end portions of interposition members 621 and 622 on the—side in the Y direction, and are engaged with protrusion D1. Engaging holes 621A and 621A1 are formed to have a size allowing protrusion D1 to be engaged with engaging holes 621A and 621A1 and allowing interposition part 62 to rotate about engaging holes 621A and 621A1 with which protrusion D1 is engaged.

Engaging holes 621B and 621A2 are disposed near the end portions of interposition members 621 and 622 on the +side in the Y direction, and are engaged with protrusion D2. Engaging holes 621B and 621A2 are sized to be engageable with protrusion D2 and to have a gap in which the inner edge of engaging holes 621B and 621A2 are movable with respect to protrusion D2.

By forming engaging holes 621A, 621B, 621A1, and 621A2 as described above, interposition part 62 is rotatable around engaging holes 621A and 621A1 (the protrusion D1) within engaging holes 621B and 621A2. Consequently, the attitude of interposition part 62 can be adjusted so that contact portions 622B of interposition part 62 are parallel to first shaft 51.

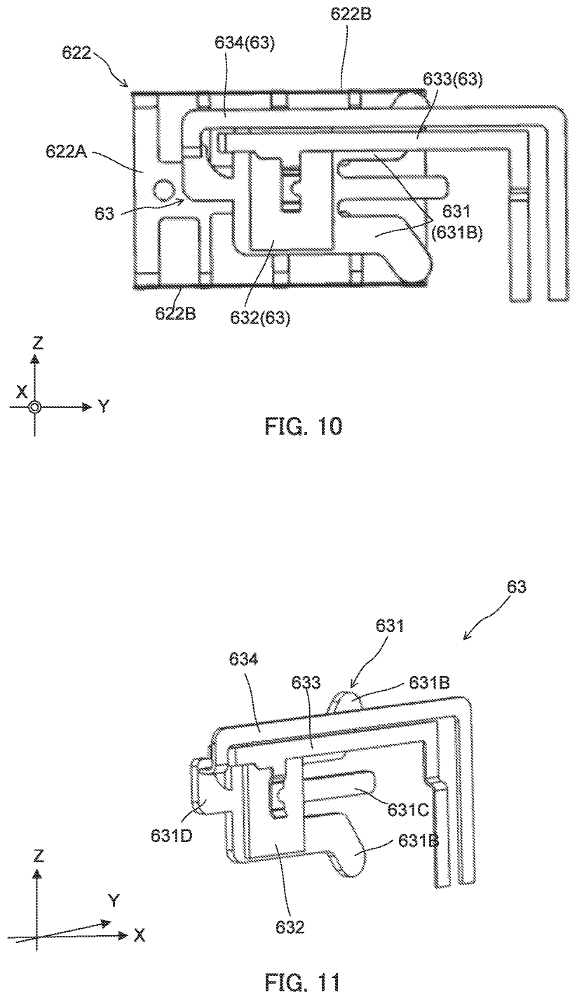

Contact portions 622B are portions with which an oscillator of ultrasonic motor 63 makes contact, and are formed by bending the end portions of main body portion 622A on both sides in the Z direction toward the side opposite to the lens part. Thus, main body portion 622A connecting together the pair of contact portions 622B is disposed to cover ultrasonic motor 63 from the—side in the X direction, and contact portions 622B are disposed to sandwich ultrasonic motor 63 (resonant portion 631) (see FIG. 10).

Interposition part 62 thus configured generates a thrust in the direction of the optical axis (Y direction) in interposition part 62 by a force acting on contact portions 622B from the oscillator of ultrasonic motor 63. As a result, it is possible to impart a thrust from interposition part 62 to drive holder 61 for movement in the direction of the optical axis (Y direction).

Further, a plurality of openings C1, C2, C3, and C4 are formed in connecting sections 622C between main body portion 622A and contact portions 622B. The plurality of openings C1, C2, C3, and C4 disposed side by side in the Y direction are four in number on each side of the connecting portions in the Y direction.

Of four openings C1, C2, C3, and C4, two openings C2 and C3 on the central side in the Y direction are configured to have lengths in the Y direction and in the Z direction that are longer than the lengths of two opening C1 and C4 on the opposite end sides in the Y direction.

Further, four openings C1, C2, C3, and C4 are formed, and thus, in connecting sections 622C, five connecting portions 622D disposed at intervals in the direction of the optical axis are formed.

The widths of connecting portions 622D in the Y direction (direction of the optical axis) increase in the order from the connecting section in the middle in the Y direction toward connecting portion 622D located on the outer side in the present embodiment. Specifically, middle connecting portion 622D in the Y direction is the narrowest of five connecting portions 622D. Connecting portions 622D at opposite ends in the Y direction are the widest of five connecting portions 622D. Connecting portions 622D located between middle connecting portion 622D and connecting portions 622D at opposite ends are wider than middle connecting portion 622D and narrower than connecting portions 622D at opposite ends.

The closer the connecting portions 622D is located to the end sides, the lower the strengths of connecting portions 622D (connecting section 622C). Thus, in the present embodiment, the strengths of connecting sections 622C are adjusted by changing the sizes of openings C1, C2, C3, and C4 and the widths of connecting portions 622D in connecting section 622C.

With the configuration as described above, it is possible to equalize the pressing force applied by oscillator 631B at each position of contact portion 622B in the entire Y direction. As a result, in the device mounted in a portable terminal such as a smart phone, for example, the moving force by interposition part 62 can be stably generated during operation of the stepless optical zoom function even when the movable part is moved within a relatively long movement range.

As illustrated in FIGS. 10 and 11, each ultrasonic motor 63 is a driving source that generates a driving force for moving drive holder 61, and is fixedly disposed on each of placement portions 111A (see FIG. 3 and the like) of first wall 111. Ultrasonic motor 63 includes resonant portion 631, piezoelectric elements 632, first electrode 633, and second electrode 634.

One of ultrasonic motors 63 on the +side in the X direction corresponds to the “first ultrasonic motor” of the present invention, and the other one of ultrasonic motors 63 on the—side in the X direction corresponds to the “second ultrasonic motor” of the present invention.

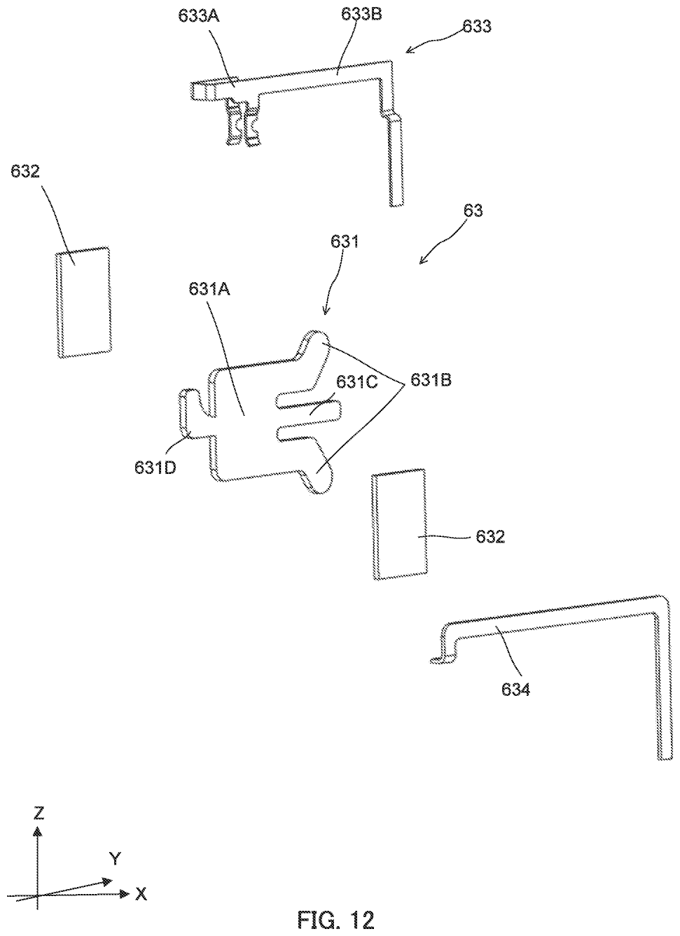

Resonant portion 631 is formed of, for example, a conductive material and resonates with the vibration of piezoelectric elements 632 to convert a vibrational motion into a linear motion of drive holder 61. Specifically, resonant portion 631 vibrates in an inclination direction inclined with respect to the direction of the optical axis (Y direction) based on the vibration of piezoelectric elements 632 so as to press interposition part 62. Accordingly, a thrust to move drive holder 61 via interposition part 62 in the direction of the optical axis is generated. Resonant portion 631 is disposed to be sandwiched between two contact portions 622B of interposition part 62. As illustrated in FIG. 12, resonant portion 631 includes body portion 631A, two oscillators 631B, protruding portion 631C, and energization portion 631D.

Body portion 631A is configured in a substantially rectangular shape, for example, and is a portion sandwiched between piezoelectric elements 632. Two oscillators 631B extend in the Y direction from opposite end portions of body portion 631A in the Z direction. Two oscillators 631B have symmetrical shapes, and their respective free end portions make contact with contact portions 622B of interposition part 62.

Protruding portion 631C extends to the +side in the Y direction from the central portion of body portion 631A in the Z direction. Energization portion 631D extends to the side opposite to protruding portion 631C (the—side in the Y direction) from the central portion of body portion 631A in the Z direction.

Each of piezoelectric elements 632 is, for example, a vibration element formed of a ceramic material in a plate shape, and generates vibration by application of a high-frequency voltage. Two piezoelectric elements 632 are disposed to sandwich body portion 631A of resonant portion 631 in the X direction, respectively.

First electrode 633 includes clamping portion 633A for clamping resonant portion 631 and piezoelectric elements 632, and electrode portion 633B to which a voltage is applied. Via clamping portion 633A for clamping piezoelectric elements 632 and the like, first electrode 633 applies a voltage to piezoelectric elements 632. Second electrode 634 is electrically connected to energization portion 631D of resonant portion 631. First electrode 633 and second electrode 634 make contact with an input terminal of below-described board part 64 inside housing 10.

Two piezoelectric elements 632 are bonded to body portion 631A of resonant portion 631 and are held in between by first electrode 633, so that these are electrically connected to one another. For example, one side of a power supply path is connected to first electrode 633, and the other side is connected to second electrode 634. A voltage is applied to piezoelectric elements 632, and a vibration is thus generated.

Resonant portion 631 has at least two resonant frequencies, and deforms in behaviors different between the resonant frequencies. In other words, the entire shape of resonant portion 631 is set such that resonant portion 631 deforms in behaviors different between the two resonant frequencies. The different behaviors mean behaviors of moving drive holder 61 to the +side and to the—side in the Y direction via interposition part 62.

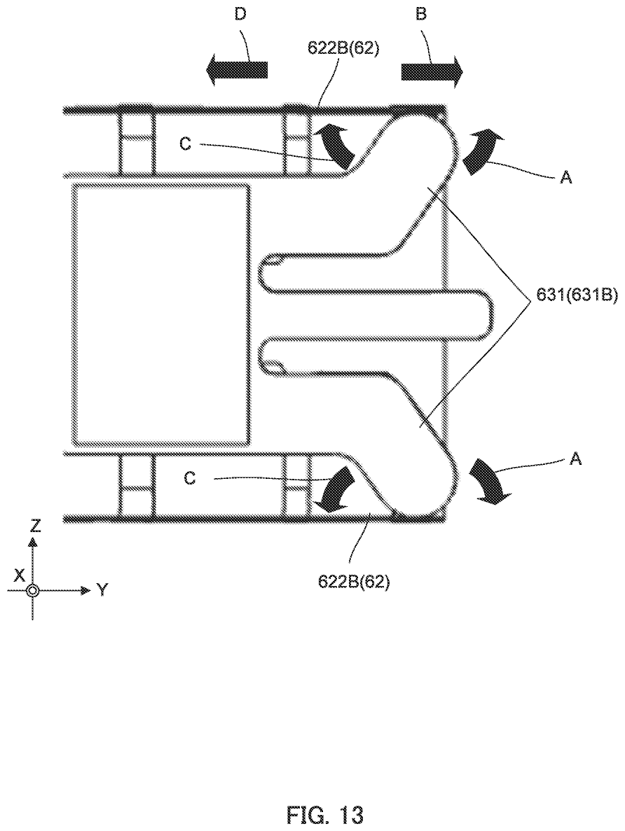

As illustrated in FIG. 13, resonant portion 631 is disposed such that either of the pair of contact portions 622B of interposition part 62 and oscillators 631B face each other. Thus, when two oscillators 631B are deformed, the tip ends of oscillators 631B press (see arrows A) contact portions 622B in a direction inclined with respect to the Y direction from the opposing sides of contact portions 622B.

When contact portions 622B are pressed in the directions of arrows A by the tip ends of oscillators 631B, reaction forces of the contact portions returning on the oscillators 631B sides are generated at contact portions 622B. In other words, interposition part 62 generates a reaction force in a direction from the outside of the pair of contact portions 622B toward the inside based on the contact between oscillators 631B and the pair of contact portions 622B.

By the reaction force of interposition part 62 with respect to the press of oscillators 631B, the friction generated between oscillators 631B and contact portions 622B causes a thrust in the Y direction in interposition part 62. Accordingly, the thrust for movement in the Y direction is applied to drive holder 61 to be bonded to interposition part 62 (see arrow B). As a result, second lens unit 32 or third lens unit 33 connected to drive holder 61 is moved in the Y direction.

Further, contact portions 622B are configured to extend in the Y direction. When pressed against oscillators 631B, contact portions 622B move in the Y direction while making sliding contact with oscillators 631B. Therefore, contact portions 622B are continuously pressed by oscillators 631B. Thus, drive holder 61 to be bonded to interposition part 62 can be moved continuously in the Y direction. Note that, at a certain resonant frequency, the pressing directions of oscillators 631B are the directions of arrows A and the sliding direction of contact portions 622B is the direction of arrows B, whereas at another resonance frequency, the pressing directions of oscillators 631B are the directions of arrows C and the sliding direction of contact portions 622B is the direction of arrows D.

Such driving operation is performed by each of ultrasonic motors 63 disposed on each of first walls 111 on both sides in the X direction. That is, ultrasonic motors 63 respectively drive second lens unit 32 and third lens unit 33 independently in the direction of the optical axis.

These movements are guided by shaft part 50, as illustrated in FIG. 7. In addition, restricting portions 114A are disposed in the vicinities of the center portions of fourth walls 114 in the Y direction.

Further, restricting portions 114A are disposed at positions where contact with drive holders 61 is possible. Therefore, when drive holder 61 on the +side in the X direction moves to the +side in the Y direction, drive holder 61 makes contact with restricting portion 114A. Further, when drive holder 61 on the—side in the X direction moves to the—side in the Y direction, drive holder 61 makes contact with restricting portion 114A. Each of restricting portions 114A thus restricts excessive movement of drive holder 61.

Each of board parts 64 is a circuit board (for example, a flexible board) having interconnections for inputting an input voltage from the outside (camera-mounted device) to ultrasonic motor 63, interconnections for outputting a signal from position detecting parts 70 to the outside, and/or the like. Board part 64 is configured to extend from the end portion of one of the pair of fourth walls 114 on the—side in the Y direction toward the +side in the Y direction.

Further, since drive holder 61 and ultrasonic motor 63 on the—side in the X direction are located on the +side in the Y direction relative to drive holder 61 and ultrasonic motor 63 on the +side in the X direction, board part 64 on the—side in the X direction is configured to be longer in the Y direction than board part 64 on the +side in the X direction. Terminals making contact with first electrodes 633 and second electrodes 634 of ultrasonic motors 63 and position detecting parts 70 are disposed at positions in board parts 64 corresponding to drive holders 61.

In addition, gaps are formed at portions corresponding to terminal placement portions 111C of first walls 111 so as to allow board parts 64 to pass therethrough. Each of board parts 64 is configured such that a portion of board part 64 corresponding to terminal placement portion 111C is disposed on terminal placement portion 111C outside housing 10 via one of the gaps. Via this portion, an input voltage from the outside is inputted to lens driving part 60 (ultrasonic motor 63) via board part 64, and a signal from position detecting part 70 is outputted to the outside (such as drive control part 100).

Further, boosting part 65 is disposed at the end portion of each of board parts 64 on the—side in the Y direction. Boosting part 65 includes an inductor that boosts the input voltage to lens driving part 60 and supplies the boosted voltage to ultrasonic motor 63.

The inductors have large individual variations. Thus, in the case of a configuration in which an inductor is disposed outside housing 10, it is necessary to additionally adjust a driving voltage of lens driving part 60 by a device on which housing 10 is mounted. In contrast, in the present embodiment, the inductors are disposed in housing 10. It is thus not necessary to adjust the driving voltage of lens driving part 60 for each device on which housing 10 is mounted. Accordingly, it is possible to improve the usability of a user.

Each of position detecting parts 70 is, for example, a Hall element that detects a position of magnet part 663, which will be described later, of drive holder 61, and is disposed on board part 64 at a position facing drive holder 61 (magnet part 663).

Next, drive holder 61 will be described in detail.

Drive holder 61 moves in the direction of the optical axis by driving ultrasonic motor 63, thereby moving second lens unit 32 or third lens unit 33 in the direction of the optical axis. Drive holder 61 includes moving part 66 and supporting part 67.

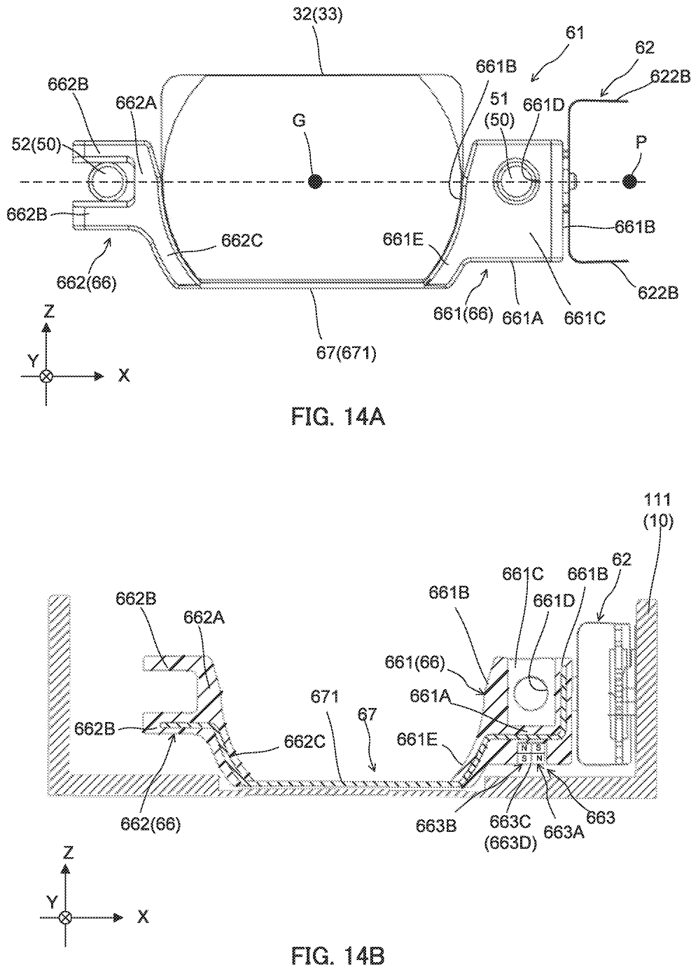

As illustrated in FIGS. 14A and 14B, moving part 66 is a portion that is supported by shaft part 50 so as to be movable in the Y direction (the direction of the optical axis), and is formed of a resin member. Moving part 66 includes first supported portion 661 and second supported portion 662.

First supported portion 661 is a portion supported by first shaft 51 at the +side of housing 10 in the X direction. First supported portion 661 is formed in the shape of a box opening on the +side in the Z direction, and includes first portion 661A, second portions 661B, and third portions 661C. Note that, while first supported portion 661 described above corresponds to second lens unit 32, the first supported portion corresponding to third lens unit 33 is supported by second shaft 52 (corresponding to the “first shaft” of the present invention).

First portion 661A is a portion forming a bottom surface (a surface on the—side in the Z direction) of first supported portion 661, and is formed in a rectangular shape in which the sides extending in the X direction are a short side and the sides extending in the Y direction are a long side.

Second portions 661B are portions forming side surfaces (opposite sides in the X direction) corresponding to the pair of long-side portions of first portion 661A. Above-described two protrusions D1 and D2 are disposed on the outer surface of one of second portions 661B on the +side in the X direction. Second portion 661B on the—side in the X direction includes connecting section 661E connected to supporting portion 67. Connecting section 661E extends from the end portion of second portion 661B on the—side in the Z direction toward the—side in the Z direction.

Third portions 661C are portions forming side surfaces (opposite sides in the Y direction) corresponding to the pair of short-side portions of first portion 661A. Shaft hole 661D through which first shaft 51 passes is formed in third portions 661C. Thus, drive holder 61 is supported by first shaft 51.

Further, the top surface portion of drive holder 61 (the portion on the +side in the Z direction) is opened (see FIG. 8). Thus, first shaft 51 can make contact only with walls defining shaft hole 661D in the pair of third portions 661C. Here, when the top surface portion of the drive holder is not opened, the first shaft can be in contact with the entire top surface portion, and would make contact with any portion of the top surface portion. Accordingly, there is a possibility that a force applied from the top surface portion (the +side in the Z direction) to the first shaft is distributed, and the movement of the drive holder is affected.

Unlike this, in the present embodiment, first shaft 51 can make contact with the pair of third portions 661C only at two places corresponding to the pair of third portions 661C. Thus, a force is applied only at the two places. Therefore, it is possible to prevent the force applied from the +side in the Z direction to first shaft 51 from becoming distributed in the Y direction entirely, and thus to prevent the movement of the drive holder from being affected.

Further, as illustrated in FIG. 14B, magnet part 663 for detecting the position of second lens unit 32 (movable part) is disposed on the surface of first supported portion 661 on the—side of first portion 661A in the Z direction. Magnet part 663 includes two magnets 663A and 663B disposed side by side in the X direction. Magnet part 663 is disposed, for example, in a recessed portion formed in the surface of first supported portion 661 on the— side in the Z direction, and faces position detecting part 70 described above.

In magnet part 663, one magnet 663A is disposed such that the N pole faces position detecting part 70, and other magnet 663B is disposed such that the S pole faces position detecting part 70. That is, two magnets 663A and 663B are magnetized in a direction along a direction (Z direction in the present embodiment) in which magnet part 663 faces position detecting part 70, and such that the different poles face position detecting part 70.

Magnets 663A and 663B are disposed in contact with each other. Therefore, the different poles are arranged adjacently at opposing surface 663C of magnet part 663 facing position detecting part 70.

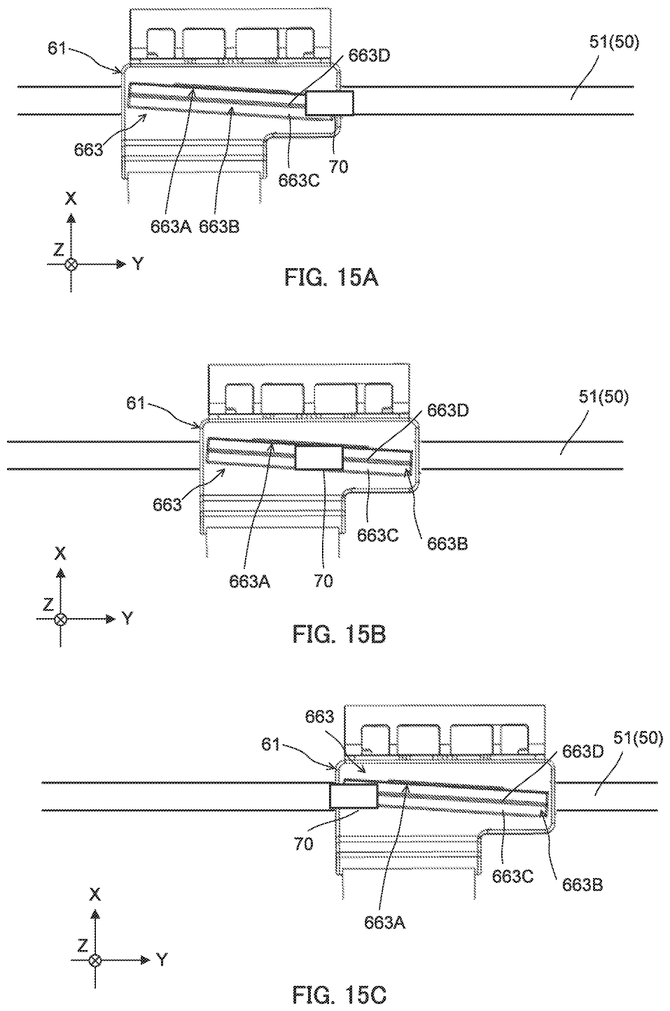

Further, as illustrated in FIGS. 15A, 15B and 15C, magnet parts 663 are disposed to be inclined with respect to the Y direction. That is, border 663D between the different poles in each of magnet parts 663 extends in an inclined manner with respect to the optical axis.

With this configuration, the proportion of the N pole and the proportion of the S pole at an opposing portion between position detecting part 70 and magnet part 663 can be made different in accordance with the movement of drive holder 61 in the Y direction.

For example, as illustrated in FIG. 15A, when the position of drive holder 61 is at the end on the—side position in the Y direction, position detecting part 70 faces the end portion of magnet part 663 on the +side in the Y direction. Position detecting part 70 faces a portion of the end portion where the proportion of the N pole of magnet 663B is large.

When drive holder 61 is moved to the +side in the Y direction, magnet part 663 also moves with drive holder 61. Accordingly, the opposing portion of position detecting part 70 with respect to magnet part 663 changes. Since magnet part 663 is inclined, the proportion of the S pole at the opposing portion with respect to position detecting part 70 gradually increases.

As illustrated in FIG. 15B, when drive holder 61 moves to a position where position detecting part 70 faces the central portion of drive holder 61, a portion where the proportion of the S pole (magnet 663B) is substantially equal to the proportion of the N pole (magnet 663A) comes to the opposing portion with respect to position detecting part 70.

Further, as illustrated in FIG. 15C, when drive holder 61 moves to a position where position detecting part 70 faces the end portion of drive holder 61 on the +side in the Y direction, a portion where the proportion of the S pole (magnet 663B) is large comes to the opposing portion with respect to position detecting part 70.

Thus, the magnitude of the magnetic force detected by position detecting part 70 can be different between the positions of drive holder 61. It is thus possible to accurately detect the position of drive holder 61 in the Y direction by position detecting part 70.

As illustrated in FIGS. 14B and 14A, second supported portion 662 is supported by second shaft 52 on the—side of housing 10 in the X direction. Second supported portion 662 includes fourth portion 662A and fifth portions 662B. Note that, while second supported portion 662 described above corresponds to second lens unit 32, the second supported portion corresponding to third lens unit 33 is supported by first shaft 51 (corresponding to the second shaft of the present invention).

Fourth portion 662A is configured to extend in the Z direction and includes connecting section 662C connected to supporting part 67. Connecting section 662C extends from the end portion of fourth portion 662A on the—side in the Z direction toward the—side in the Z direction.

A pair of fifth portions 662B are disposed at opposite end portions of fourth portion 662A in the Z direction, and extend from the opposite end portions toward the—side in the X direction. Since second shaft 52 passes between the pair of fifth portions 662B, second supported portion 662 is supported by second shaft 52.

Supporting part 67 is a portion that supports second lens unit 32 (third lens unit 33) at a position closer to the optical axis (closer to the center of housing 10 in the X direction) than shaft part 50 is to the optical axis. Supporting part 67 is formed of metal member 671. Metal member 671 is insert-molded into connecting sections 661E and 662C of moving part 66.

Portions of metal member 671 inserted into moving part 66 have shapes conforming the shape of moving part 66. Thus, supporting part 67 is integrally formed with moving part 66. Second lens unit 32 (third lens unit 33) is adhesively fixed to metal member 671 of supporting part 67. The method of fixing second lens unit 32 (third lens unit 33) to supporting part 67 may be any method as long as second lens unit 32 (third lens unit 33) can be fixed.

Supporting part 67 is disposed such that the end portion of the supporting part on the +side in the X direction is connected to connecting section 661E of first supported portion 661, and the end portion of the supporting part on the—side in the X direction is connected to connecting section 662C of second supported portion 662. Accordingly, supporting part 67 is positioned on the—side in the Z direction in comparison to first shaft 51 and second shaft 52, and accordingly, second lens unit 32 (third lens unit 33) is positioned on the—side in the Z direction in comparison to first shaft 51 and second shaft 52.

The height range of first shaft 51 and second shaft 52 supporting drive holder 61 is a range including the height position of center G of second lens unit 32 (third lens unit 33). The height range of first shaft 51 means a range from the height position of the end portion of first shaft 51 on the +side in the Z direction to the height position of the end portion of first shaft 51 on the—side in the Z direction. The height range of second shaft 52 means a range from the height position of the end portion of second shaft 52 on the +side in the Z direction to the height position of the end portion of second shaft 52 on the—side in the Z direction. Since first shaft 51 and second shaft 52 have the same diameter and have the same height position, the height ranges of first shaft 51 and second shaft 52 are the same height range.

Specifically, the height positions of the axial centers of first shaft 51 and second shaft 52 are the same as the height position of center G of second lens unit 32 (third lens unit 33) (see the broken line in FIG. 14A).

Further, intermediate position P between the pair of contact portions 622B of interposition part 62 is the same as the height position of center G of second lens unit 32 (third lens unit 33) (see the broken line in FIG. 14A).

In the present embodiment configured as described above, second lens unit 32 (third lens unit 33) is supported by drive holder 61.

In the meantime, when the ultrasonic motor is used as the driving part, it is conceivable to separately dispose the movable part for holding the movable lens and the drive holder for transmitting the driving force of the ultrasonic motor to the movable part.

For example, two types of guide shafts for the drive holder and for the movable part are provided, and the drive holder and the movable part are connected by a connecting member (a spring member or the like for absorbing a positional deviation between the drive holder and the movable part) to transmit a driving force to the movable part via the drive holder to move the movable part.

With such a configuration, the drive holder and the movable part are separately moved. Thus, there is a risk of occurrence of a response delay of the driving force from the drive holder to the movable part. In addition, there is a risk of inclination of the movable part caused due to the response delay.

Further, since the position detection magnet part is disposed in the drive holder, the position of the movable part is detected by detecting the position of the drive holder. However, in the case of the configuration in which the position of the movable part is detected in this way, the position detecting part does not directly detect the position of the movable part. Thus, there is a possibility that the position of the movable part cannot be accurately managed.

In contrast, since drive holder 61 supports second lens unit 32 (third lens unit 33) in the present embodiment, the movement of drive holder 61 itself is the movement of second lens unit 32 (third lens unit 33). Consequently, it is possible to suppress the occurrence of a response delay of the driving force to second lens unit 32 (third lens unit 33), and it is possible to accurately detect the position of second lens unit 32 (third lens unit 33), and thus to accurately manage the position.

Further, since second lens unit 32 (third lens unit 33) is supported by supporting part 67 of drive holder 61, it is possible to suppress the occurrence of inclination of second lens unit 32 (third lens unit 33) with respect to drive holder 61 due to the above-described response delay.

Further, the height range of first shaft 51 and second shaft 52 is a range including the height position of the center of second lens unit 32 (third lens unit 33). Here, the drive holder moves along the first shaft and the second shaft. Thus, when rattling or misalignment is supposed to occur in each component, the farther the component is from the height range of the first shaft and the second shaft, the higher the degree of inclination or the like due to rattling or misalignment tends to be. Therefore, the more the center of the movable lens deviates from the height range, the more the incident light onto the image capturing device is affected.

Unlike this, the height range of first shaft 51 and second shaft 52 is a range including the height position of the center of second lens unit 32 (third lens unit 33) in the present embodiment. It is thus possible to reduce the degree of inclination of the movable lens caused by rattling or misalignment. Consequently, it is possible to reduce the degree of influence caused by rattling or misalignment in each component.

Further, intermediate position P between the pair of contact portions 622B of second interposition member 622 is the same as height position G of the center of second lens unit 32 (third lens unit 33).

Thus, the thrust of second interposition member 622 via ultrasonic motor 63 can be easily transmitted to second lens unit 32 (third lens unit 33).

Further, since magnet part 663 is disposed in a portion of first supported portion 611 of drive holder 61 that forms the bottom surface. Thus, magnet part 663 does not protrude in the space between first wall 111 and drive holder 61. Consequently, the space between first wall 111 and drive holder 61 can be effectively utilized. Thus, the driving force of drive holder 61 can be increased by increasing the size of ultrasonic motor 63, for example.

Further, since a portion of supporting part 67 is metal member 671, the thickness of supporting part 67 can be reduced as compared with a configuration in which the supporting part is a resin member. Therefore, the length of housing 10 (lens driving device) in the Z direction can be reduced.

Further, since supporting part 67 is metal member 671, the strength of the portion of supporting part 67 can be increased.

Note that, in the above-described embodiment, moving part 66 includes first supported portion 661 and second supported portion 662, but the present invention is not limited thereto. Moving part 66 may be composed only of the first supported portion. In this case, the shaft part may include only the first shaft.

Further, in the above embodiment, the configuration includes two lens driving parts 60. However, the present invention is not limited to this, and may have a configuration having one or more lens driving parts.

In the above-described embodiment, supporting part 67 is made of a metal member, but the present invention is not limited thereto, and may be made of a material other than a metal member.

Further, in the above embodiment, the axial center of first shaft 51 and second shaft 52 is the same position as the height position of the center of the movable lens. However, the present invention is not limited thereto, and the height position of the center of the movable lens may be within the height range of the shaft part.

In the above-described embodiment, boosting part 65 (inductor) is disposed in housing 10, but the present invention is not limited thereto, and the boosting part may be disposed outside the housing.

Further, in the above-described embodiment, the intermediate position between the pair of contact portions 622B of second interposition member 622 is the same as the height position of the center of the movable lens. However, the present invention disclosure is not limited thereto and may be slightly deviated from the height position.

Further, in the above-described embodiment, one position detecting part 70 is provided in each of drive holders 61, but the present invention is not limited thereto. For example, a configuration may be employed which includes a plurality of position detecting parts 70 disposed side by side in the direction of the optical axis (Y direction). With such a configuration, it is possible to further improve the accuracy of the position detection for drive holder 61.

In the above embodiment, side wall portion 11 and bottom wall portion 12 of housing 10 are formed by insert molding. However, the present invention is not limited to this, and the bottom wall portion may be adhesively fixed to side wall portion 11.

Further, the above embodiment employs the configuration having two movable lenses composed of second lens unit 32 and third lens unit 33, but the present invention is not limited to this, and the configuration may have a single movable lens, or three or more movable lenses.

Further, the above embodiment employs the configuration having four lens units, but the present invention is not limited to this, and any number of lens units may be provided as long as the configuration has at least one movable lenses. In addition, in the case of a configuration including one movable lens, the number of lens driving parts is also one.

In the above embodiment, interposition part 62 is formed by bending a plate-like metal member, but the present invention is not limited to this, and the main body portion and the contact portion forming the interposition part may be formed by separate members.

In the above embodiment, drive holder 61 and interposition part 62 are formed of separate members, but the present invention is not limited thereto. For example, drive holder 61 and interposition part 62 may be integrally formed.

The above embodiment has the configuration in which the bottom wall portion includes the bent portions or half punches, but the present invention is not limited to this, and a configuration may also be used in which the bottom wall portion does not includes any bent portion or half punch.

In the above embodiment, resonant portion 631 includes two oscillators 631B, but the present invention is not limited to this, and the present invention may have a configuration in which the resonant portion includes one oscillator, for example.

In the above embodiment, the drive control part, the reflection drive control part, and the image capturing control part are disposed separately, but the present invention is not limited to this, and at least two of the drive control part, the reflection drive control part, and the image capturing control part may be composed of one control part.

In addition, in the above embodiment, restricting portion 114A is provided, but the present invention is not limited thereto, and no restricting portion may be provided.

For example, while a smartphone serving as a camera-equipped mobile terminal has been described in the above embodiment as an example of the camera-mounted device including camera module 1, the present invention is applicable to a camera-mounted device including a camera module and an image processing part that processes image information obtained by the camera module. The camera-mounted device encompasses an information apparatus and a transporting apparatus. The camera-mounted device encompasses an information apparatus and a transporting apparatus. Examples of the information apparatus include a camera-mounted mobile phone, a note-type personal computer, a tablet terminal, a mobile game machine, a web camera, drone, and a camera-mounted in-vehicle device (for example, a rear-view monitor device or a drive recorder device). In addition, examples of the transporting apparatus include an automobile, drone, and/or the like.

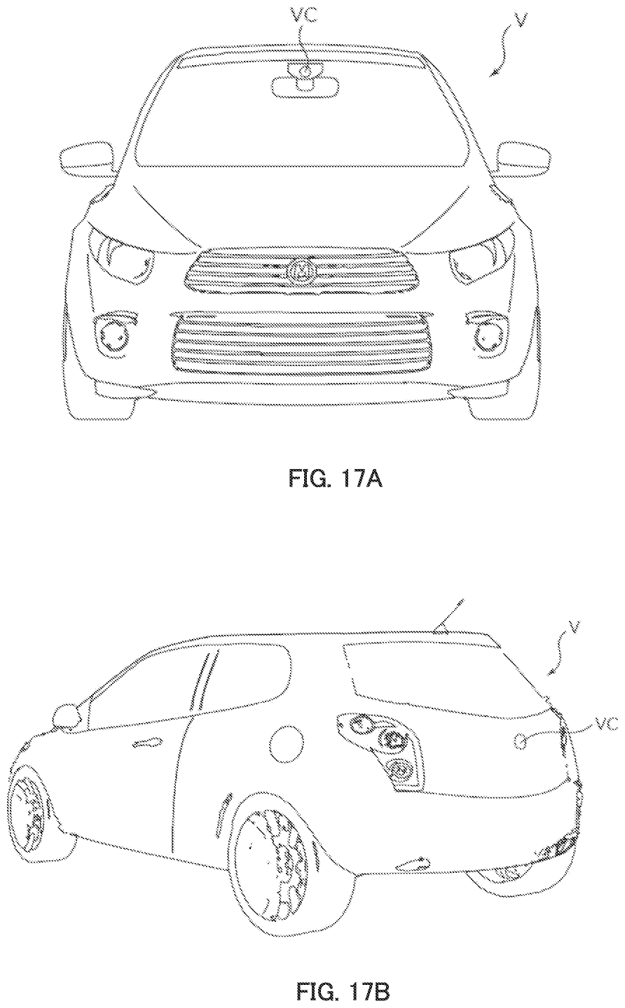

FIGS. 17A and 17B illustrate automobile V serving as the camera-mounted device in which in-vehicle camera module VC (Vehicle Camera) is mounted. FIG. 17A is a front view of automobile V and FIG. 17B is a rear perspective view of automobile V. In automobile V, camera module 1 described in the embodiment is mounted as in-vehicle camera module VC. As illustrated in FIGS. 17A and 17B, in-vehicle camera module VC may, for example, be attached to the windshield so as to face forward, or to the rear gate so as to face backward. In-vehicle camera module VC is used for rear monitoring, drive recording, collision avoidance control, automatic drive control, and the like.

In addition, the aforementioned embodiments merely describe examples of implementations for practicing the present invention, and should not be construed as limiting the technical scope of the present invention. That is, the present invention can be embodied in various forms without departing from the spirit, scope, or principal features of the present invention. For example, the shape, size, number, and material of each part described in the above embodiment are merely examples, and can be changed as appropriate.

The disclosure of U.S. provisional Patent Application No. 63/059,244, filed on Jul. 31, 2020, including the specification, drawings and abstract is incorporated herein by reference in its entirety.

### INDUSTRIAL APPLICABILITY

The lens driving device according to the present invention is useful for a lens driving device, a camera module, and a camera-mounted device capable of suppressing a response delay of a driving force to a movable part and an inclination of the movable part and accurately managing a position of the movable part.

### REFERENCE SIGNS LIST

1 Camera module
10 Housing
11 Side wall portion
12 Bottom wall portion
20 Reflection driving part
21 Reflecting housing
22 Mirror
23 Reflection drive control part
30 Lens part
31 First lens unit
31A Main body portion
31B Supported portion
32 Second lens unit
33 Third lens unit
34 Fourth lens unit
34A Main body portion
34B Supported portion
40 Image capturing part
50 Shaft part
51 First shaft
52 Second shaft
60 Lens driving part
61 Drive holder
62 Interposition part
63 Ultrasonic motor
64 Board part
65 Boosting part
66 Moving part
67 Supporting part
70 Position detecting part
100 Drive control part
111 First wall
111A Placement portion
111B Engaged portion
111C Terminal placement portion
112 Second wall
112A Shaft support portion
112B Opening portion
113 Third wall
113A Bridging portion
113B Shaft support portion
114 Fourth wall
114A Restricting portion
121 Positioning portion
122 Bent portion
123 Half punch
200 Image capturing control part
621 First interposition member
621A Engaging hole
621B Engaging hole
622 Second interposition member
622A Main body portion
622B Contact portion
622C Connecting portion
622D Connecting section
631 Resonant portion
631A Body portion
631B Oscillator
631C Protruding portion
631D Energization portion
632 Piezoelectric element
633 First electrode
633A Clamping portion
633B Electrode part
634 Second electrode
661 First supported portion
661A First portion
661B Second portion
661C Third portion
661D Shaft hole
661E Connecting section
662 Second supported portion
662A Fourth portion
662B Fifth portion
662C Connecting section
663 Magnet part
663A Magnet
663B Magnet
663C Opposing surface
663D Border

1. A lens driving device, comprising:
a movable part that is capable of holding a movable lens;
a driving part that includes an ultrasonic motor and drives the movable part in a direction of an optical axis; and
a shaft part that extends in the direction of the optical axis and supports the movable part, wherein
the driving part includes:
a moving part supported by the shaft part so as to be movable in the direction of the optical axis, and
a supporting part that is connected to the moving part and supports the movable part at a position closer to the optical axis than the shaft part is to the optical axis.

2. The lens driving device according to claim 1, wherein
at least a portion of the supporting part corresponding to the movable part is formed of a metal member.

3. The lens driving device according to claim 2, wherein
the supporting part and the moving part that is a resin member are integrally formed by insert molding.

4. The lens driving device according to claim 1, wherein
the shaft part is located in a range corresponding to a height position of a center of the movable lens.

5. The lens driving device according to claim 1, wherein:
the ultrasonic motor is disposed on one side with respect to the optical axis,
the shaft part includes a first shaft disposed on the one side with respect to the optical axis and a second shaft disposed on another side with respect to the optical axis, and
the moving part includes:
a first supported portion connected to the supporting part at the one side and supported by the first shaft, and
a second supported portion connected to the supporting part at the other side and supported by the second shaft.

6. The lens driving device according to claim 5, wherein
the first supported portion is formed in a shape of a box surrounding the first shaft, and
the first supported portion includes, at a portion forming a bottom surface of the first supported portion, a magnet part for detecting a position of the movable part.

7. The lens driving device according to claim 6, further comprising:
a position detecting part that is disposed to face the portion forming the bottom surface and detects a position of the magnet part.

8. The lens driving device according to claim 5, wherein:
the first supported portion includes a pair of side surface portions facing each other in the direction of the optical axis and having a shaft hole through which the first shaft passes, and
the first shaft is capable of making contact with the first supported portion at two places corresponding to the shaft hole in the first supported portion.

9. The lens driving device according to claim 1, wherein:
the ultrasonic motor includes a resonant portion composed of a resonating oscillator,
the driving part includes an interposition part interposed between the ultrasonic motor and the moving part,
the interposition part includes a pair of contact portions that are disposed to sandwich the resonant portion and make contact with the resonating oscillator, and
an intermediate position between the pair of contact portions is the same as a height position of a center of the movable lens.

10. The lens driving device according to claim 1, wherein:
the movable part includes a first movable part and a second movable part that are capable of holding a first movable lens and a second movable lens, respectively,
the driving part includes a first driving part and a second driving part that drive the first movable part and the second movable part in the direction of the optical axis,
the first driving part and the second driving part include a first ultrasonic motor and a second ultrasonic motor, respectively, and
the first ultrasonic motor and the second ultrasonic motor are disposed on opposite sides with respect to the optical axis, and independently drive the first movable part and the second movable part respectively in the direction of the optical axis.

11. A camera module, comprising:
a lens driving device according to claim 1;
a lens part including the movable lens held by the movable part; and
an image capturing part configured to capture a subject image imaged by the lens part, wherein
the movable lens is driven in the direction of the optical axis.

12. A camera-mounted device that is an information apparatus or a transporting apparatus, the camera-mounted device comprising:
a camera module according to claim 11; and
an image capturing control part that processes image information obtained by the camera module.
